(19) United States
(12) Patent Application Publication
(10) Pub. No.: US 2014/0102962 A1
(43) Pub. Date: Apr. 17, 2014

(54) PORTABLE WATER FILTRATION BOTTLE

(71) Applicant: TIEN-CHI YAO, New Taipei City (TW)

(72) Inventors: SHIH-YI CHANG, Hsinchu City (TW); TIEN-CHI YAO, New Taipei City (TW)

(73) Assignee: TIEN-CHI YAO, New Taipei City (TW)

(21) Appl. No.: 14/051,558

(22) Filed: Oct. 11, 2013

(30) Foreign Application Priority Data
Oct. 15, 2012 (TW) 101219864

(51) Int. Cl. C02F 1/32

(52) U.S. Cl. CPC C02F 1/325
USPC 210/94; 210/136

(57) ABSTRACT

A portable water filtration bottle includes a main unit having a containing space. The main unit is provided orderly from an water inlet to a water outlet with a first cover unit covering the water inlet; a filtration tank which contains a filter and is at a side of the containing space, with the filtration tank being connected with a non-return device at a side close to the containing space; a bactericidal lamp tube device which is at another side of the containing space; and a second cover unit covering the water outlet. Accordingly, water entering from the water inlet is filtered and then flows into the containing space under a control of a check valve. Next, water is sterilized by the bactericidal lamp tube device. Therefore, users are able to drink clean water at all times and hygiene of drinking water can be improved.

### BACKGROUND OF THE INVENTION

a) Field of the Invention

The present invention relates to a portable water filtration bottle, and more particularly to a portable water filtration bottle with a sterilization function.

b) Description of the Prior Art

In current society, the aggressive development in industries and businesses and the continuous innovation in technologies have already changed our living environment considerably, bringing in all kinds of pollution to nature following the business behaviors. For example, the living environment surrounding us, and air and water that is indispensable in our lives, etc., have been contaminated severely. Therefore, all kinds of filtering, sanitizing and sterilization equipment are being developed to filter, sanitize and sterilize air, water or all kinds of appliances, so that people can live without worrying and the appliances can be used more safely.

Accordingly, the shortcomings of the existing portable water filtration bottles are improved further by the present inventor, thereby providing a portable water filtration bottle that can achieve a better practical value.

### SUMMARY OF THE INVENTION

The primary object of the present invention is to provide a portable water filtration bottle with a sterilization function, such that users can drink clean water at all times and hygiene of drinking water can be improved.

To achieve the abovementioned object, the portable water filtration bottle of the present invention includes a main unit, wherein an interior of the main unit is provided with a containing space, and the main unit is provided orderly from an water inlet to an water outlet with a first cover unit which covers the water inlet; a filtration tank which is provided with a filter and is disposed at a side of the containing space, with the filtration tank being connected with a non-return device at a side in proximity to the containing space; a bactericidal lamp tube device which is disposed at another side of the containing space; and a second cover unit which covers the water outlet.

According to the abovementioned portable water filtration bottle, an inner wall of the first cover unit is provided with threads which are screwed with threads disposed on a wall at the water inlet of the main unit.

According to the abovementioned portable water filtration bottle, the filter is a filtration bucket.

According to the abovementioned portable water filtration bottle, the non-return device is opened respectively with an outlet pore and an inlet pore in a center of two end surfaces facing toward the water outlet and the water inlet. In addition, an interior of the non-return device is provided with a check valve, and a span length of the check valve is shorter than that of the two end surfaces facing toward the water outlet and the water inlet. In a preferred embodiment of the present invention, the check valve is a silicone plate.

According to the abovementioned portable water filtration bottle, an internal surface of the check valve facing toward the water outlet is provided with a slope along which a wall of the non-return device is bended inward to a center, forming an arc-shaped end surface.

According to the abovementioned portable water filtration bottle, a wall of the main unit opposite to the containing space is transparent.

According to the abovementioned portable water filtration bottle, the bactericidal lamp tube device further includes a battery, a circuit board which is connected with the lamp tube, and a light switch. The battery is connected electrically with the light switch that is also connected electrically with the circuit board. Electricity is provided to the lamp tube by turning on the light switch to execute sterilization. Besides that, the light switch is designed as a press button and is disposed on the second cover unit.

According to the abovementioned portable water filtration bottle, the lamp tube is an ultraviolet lamp tube and is put into the containing space after being emplaced in an air-tight sleeve. Vacuum is formed between the lamp tube and the air-tight sleeve, such that a sterilizing light beam which is released from the lamp tube can reach to an exterior side of the air-tight sleeve almost without any attenuation.

According to the abovementioned portable water filtration bottle, the second cover unit is a sliding lid.

In conclusion, the portable water filtration bottle according to the present invention is provided with following advantages:
1. The filtering function is combined with the sterilization function, allowing users to have a portable water filtration bottle with both functions that the users can drink clean water at all times and hygiene of drinking water can be improved.
2. When the filter reaches to an upper limit of time of use, it can be taken out for replacement easily, thereby increasing a lifetime of use of the portable water filtration bottle.
3. When the sterilization function needs to be activated, the users can just press gently the light switch on the second cover unit to start the sterilization process.
4. As the wall of the main unit opposite to the containing space is transparent, the users can be aware of the state of the bactericidal lamp tube device; for example, when the bactericidal lamp tube device is turned on, the lamp tube will illuminate and light will be extinguished when the sterilization process is finished.
5. The bactericidal lamp tube device is powered by a battery and therefore, when the battery is low, it can be taken out for replacement easily, allowing the bactericidal lamp tube device to continue operation.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a side cutaway view of the present invention.

FIG. 2 shows a first schematic view of an implementation state, according to the present invention.

FIG. 3 shows a second schematic view of the implementation state, according to the present invention.

FIG. 4 shows a third schematic view of the implementation state, according to the present invention.

### DETAILED DESCRIPTION OF THE PREFERRED EMBODIMENTS

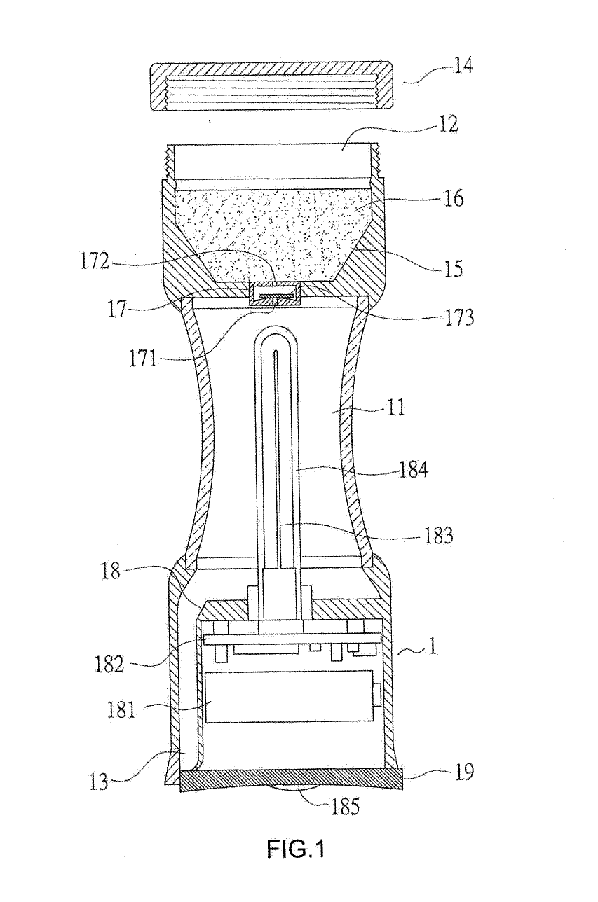

FIG. 1 discloses a side cutaway view of the present invention. A portable water filtration bottle comprises a main unit 1, an interior of the main unit 1 is provided with a containing space 11, a side of the main unit 1 is a water inlet 12, and another side is a water outlet 13. The main unit 1 is provided orderly from the water inlet 12 to the water outlet 13 with a first cover unit 14 which covers the water inlet 12; a filtration tank 15 which is disposed at a side of the containing space 11 and is provided with a filter 16 which is a filtration bucket in the preferred embodiment of the present invention, with an exterior side of the filtration tank 15 in proximity to the containing space 11 being connected with a non-return device 17, the non-return device 17 being opened respectively with an outlet pore 171 and an inlet pore 172 in a center of two end surfaces facing toward the water outlet 13 and the water inlet 12, and an interior of the non-return device 17 being provided with a check valve 173; a bactericidal lamp tube device 18 which is disposed at another side of the containing space 11; and a second cover unit 19 which covers the water outlet 13.

The bactericidal lamp tube device 18 further includes a battery 181, a circuit board 182 which is connected with the lamp tube 183, and a light switch 185. The battery 181 is connected electrically with the light switch 185, and the light switch 185 is also connected electrically with the circuit board 182. An electric current is provided to the circuit board 182 to illuminate the lamp tube 183 to execute sterilization, by turning on the light switch 185. The lamp tube 183 is an ultraviolet lamp tube and is put into an air-tight sleeve 184 before being transfixed in the containing space 11. Vacuum is formed between the lamp tube 183 and the air-tight sleeve 184, such that a sterilizing light beam released by the lamp tube 183 can reach to an exterior side of the air-tight sleeve 184 almost without any attenuation.

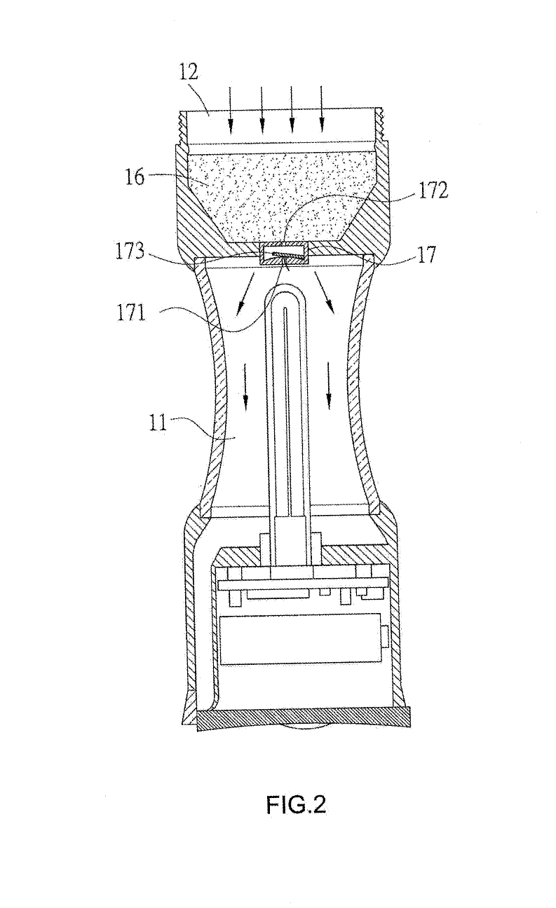

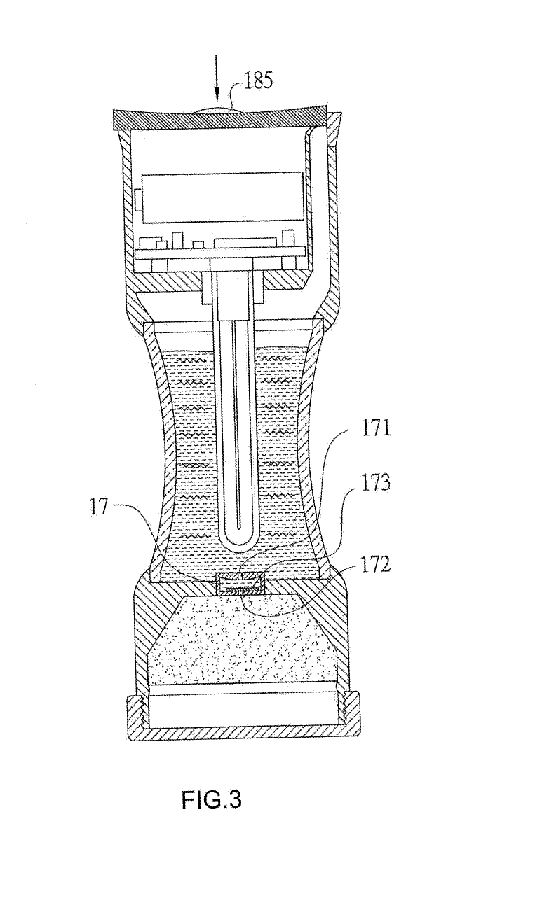

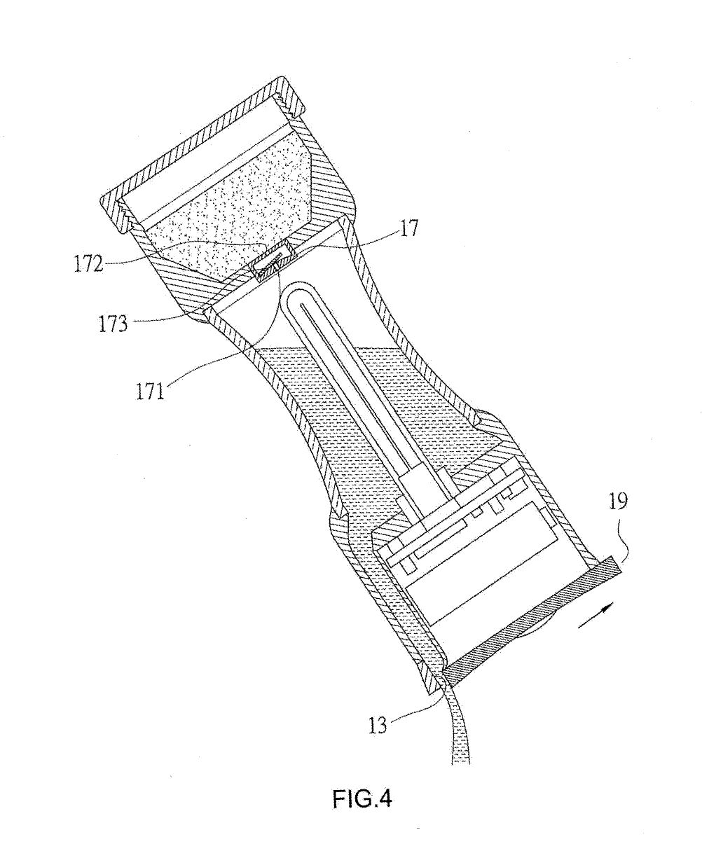

FIGS. 2 to 4 show three schematic views of an implementation state of the present invention. Referring to FIG. 1 to FIG. 4, when a user is to utilize the portable water filtration bottle, he or she first turns upward the water inlet 12 covered by the first cover unit 14 and then pours in water from the water inlet 12 after opening the first cover unit 14. Water will pass through the filter 16 made of many kinds of filter materials and then rests for a little while before flowing slowly into the containing space 11 of the main unit 1, waiting for a sterilization operation. The non-return device 17 is provided with a movable check valve 173 which is a silicone plate in the preferred embodiment of the present invention. An inner surface of the non-return device 17 facing toward the water outlet 13 is provided with a slope along which a wall of the non-return device 17 is bended inward to a center, forming an arc-shaped end surface. When the main unit 1 is emplaced with the water inlet 12 facing upward, the check valve 173 will slide down to the arc-shaped end surface by gravity. As a span length of the check valve 173 is shorter than that of two end surfaces of the non-return device 17 facing toward the water outlet 13 and the water inlet 12, there is a gap left between the check valve 173 and the inner wall of the non-return device 17. Furthermore, as the arc-shaped end surface design prohibits the check valve 173 from being fully attached on the arc-shaped end surface flatly, there leaves a gap between the check valve 173 and the outlet pore 171 in the center of the arc-shaped end surface, so that water after filtration can flow into the containing space 11. On the contrary, when the main unit 1 is emplaced with the water outlet 13 facing upward, the check valve 173 will slide down to an end surface of the non-return device 17 in proximity to the filtration tank 15 by gravity and will be just abutted at the inlet pore 172, so that water that has been already in the containing space 11 cannot flow reversely into the filtration tank 15 from the inlet pore 172, and will be kept in the containing space 11. Accordingly, the issues that the filter materials of the filter 16 are submerged in water for a long time and water is filtered repeatedly can be avoided. When water is almost filled into the containing space 11, the user can cover the water inlet 12 with the first cover unit 14 and in the preferred embodiment of the present invention, an inner wall of the first cover unit 14 is provided with threads which are screwed with threads on a wall at the water inlet 12 of the body 1. Next, the main unit 1 is emplaced with the water outlet 13 facing upward. At this time, the user can turn on the light switch 185 on the second cover unit 19, and the lamp tube 183 of the bactericidal lamp tube device 18 will illuminate to execute sterilization. In the preferred embodiment of the present invention, the light switch 185 is a press button. In addition, a wall of the main unit 1 opposite to the containing space 11 is transparent, allowing the user to be aware of the state of the bactericidal lamp tube device 18. For example, when the bactericidal lamp tube device 18 is turned on, the lamp tube 183 will illuminate, whereas light will be extinguished when the sterilization process is finished. After light has been extinguished, the user can open the second cover unit 19 to drink clean water that has been undergone with filtering and sterilization, from the water outlet 13 directly. The second cover unit 19 is a sliding lid in the preferred embodiment of the present invention.

Accordingly, in the present invention, the filtering function and the sterilization function are combined together, allowing the user to have a portable water filtration bottle with both functions that he or she can drink clean water at all times and hygiene of drinking water can be improved.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A portable water filtration bottle comprising a main unit, an interior of the main unit is provided with a containing space, a side of the main unit is a water inlet, another side of the main unit is a water outlet, and the main unit is provided orderly from the water inlet to the water outlet with:
a first cover unit which covers the water inlet;
a filtration tank which is provided with a filter and is disposed at a side of the containing space, with the filtration tank being connected with a non-return device at a side in proximity to the containing space;
a bactericidal lamp tube device which is disposed at another side of the containing space; and
a second cover unit which covers the water outlet.

2. The portable water filtration bottle according to claim 1, wherein an inner wall of the first cover unit is provided with threads which are screwed with threads disposed on a wall at the water inlet of the main unit.

3. The portable water filtration bottle according to claim 1, wherein the filter is a filtration bucket.

4. The portable water filtration bottle according to claim 1, wherein the non-return device is opened respectively with an outlet pore and an inlet pore in a center of two end surfaces facing toward the water outlet and the water inlet, and an interior of the non-return device is provided with a check valve.

5. The portable water filtration bottle according to claim 4, wherein the check valve is a silicone plate.

6. The portable water filtration bottle according to claim 4, wherein an inner surface of the non-return device facing toward the water outlet is provided with a slope along which a wall of the non-return device is bended inward to a center, forming an arc-shaped end surface.

7. The portable water filtration bottle according to claim 6, wherein a span length of the check valve is shorter than that of two end surfaces of the non-return device facing toward the water outlet and the water inlet.

8. The portable water filtration bottle according to claim 1, wherein a wall of the main unit opposite to the containing space is transparent.

9. The portable water filtration bottle according to claim 1, wherein the bactericidal lamp tube device further includes a battery, a circuit board which is connected with the lamp tube, and a light switch, with the battery, the circuit board and the light switch being all connected together electrically.

10. The portable water filtration bottle according to claim 9, wherein the light switch is a press button and is disposed on the second cover unit.

11. The portable water filtration bottle according to claim 9, wherein the lamp tube is an ultraviolet lamp tube.

12. The portable water filtration bottle according to claim 9, wherein the lamp tube is put into an air-tight sleeve and vacuum is formed between the lamp tube and the air-tight sleeve.

13. The portable water filtration bottle according to claim 1, wherein the second cover unit is a sliding lid.
